(19) United States
(12) Patent Application Publication
(10) Pub. No.: US 2011/0167130 A1
(43) Pub. Date: Jul. 7, 2011

(54) Informational Video Delivery Software And Associated Methods

(75) Inventor: Andrea Cochran, Maitland, FL (US)

(73) Assignee: WAKEUPCALL.TV, LLC, Maitland, FL (US)

(21) Appl. No.: 12/985,466

(22) Filed: Jan. 6, 2011

Related U.S. Application Data
(60) Provisional application No. 61/292,532, filed on Jan. 6, 2010.

(51) Int. Cl. G06F 17/30; G06F 15/16

(52) U.S. Cl. 709/217; 707/812; 707/E17.005

(57) ABSTRACT

A system for delivering informational content to a portable electronic device includes a processor placeable in signal communication with a network. Software is resident on the processor that is adapted for providing an application available to and loadable on a mobile device of a user and receiving over the network access data for the user device and a user selection of a time to receive content. The user device access data and time selection are stored, and deliverable content is provided. At substantially the user-selected time, the software assembles content and makes it available to the user device. The user can either elect to access the content or have the content “pushed” directly to the device.

### CROSS-REFERENCE TO RELATED APPLICATION

This application claims priority to provisional patent application Ser. No. 61/292,532, filed on Jan. 6, 2010.

### BACKGROUND OF THE INVENTION

### Field of the Invention

The present invention relates to systems and methods for delivering informational videos electronically, and, more particularly, for delivering informational videos to portable electronic devices.

Portable electronic devices, such as laptop computers, smart telephones, and personal digital assistants, are capable of serving many functions. For example, smart telephones may be used to send and receive electronic mail, access the Internet, watch movies, listen to music, take photographs, provide navigation capabilities, etc.

Another use of such portable devices is as an alarm clock, providing ease of use and convenience. For instance, when the alarm feature notifies a user that it is time to wake up, the user can quickly and easily turn off the alarm and immediately access his/her email, the Internet, etc., all from the comfort of his/her bed. Over time, it is expected that these devices will be capable of rendering additional functions and improve those already in use.

At present, however, there is no known system or method for providing content to a user within the alarm application.

Therefore, it would be beneficial to provide an application that combines the alarm functions known in mobile devices with up-to-date content for the user.

### SUMMARY OF THE INVENTION

The present invention is directed to systems and methods for delivering informational content to a portable electronic device. In one aspect a system comprises a processor placeable in signal communication with a network and a timer in signal communication with the processor. A database is accessible by the processor.

Software is resident on the processor that comprises code segments adapted for providing an application available to and loadable on a mobile device of a user and receiving over the network access data for the user device and a user selection of a time to receive content. The software further comprises code segments for storing in the database the user device access data and time selection and for receiving and storing in the database deliverable content. At substantially the user-selected time, the software assembles content and makes available to the user device via the network the assembled content.

In another aspect a system is disclosed for providing informational content to a user. The system comprises a portable electronic device that comprises a processor that is placeable in signal communication with a network, and an input and an output that are in signal communication with the processor.

An application is resident on the device processor that comprises code segments adapted for receiving via the input a user selection of a time to receive content and for transmitting the user-selected time to an administrator site over the network. The application further comprises a code segment adapted for accessing content assembled and delivered by the administrator site at substantially the user-selected time.

Methods are also provided commensurate with the above-described systems.

### BRIEF DESCRIPTION OF THE DRAWING

FIG. 1 is a system schematic for an exemplary embodiment of the content-delivery system of the present invention.

FIGS. 2A-2B is a flowchart of an exemplary embodiment of a method for delivering content to a mobile device.

### DETAILED DESCRIPTION OF THE PREFERRED EMBODIMENTS

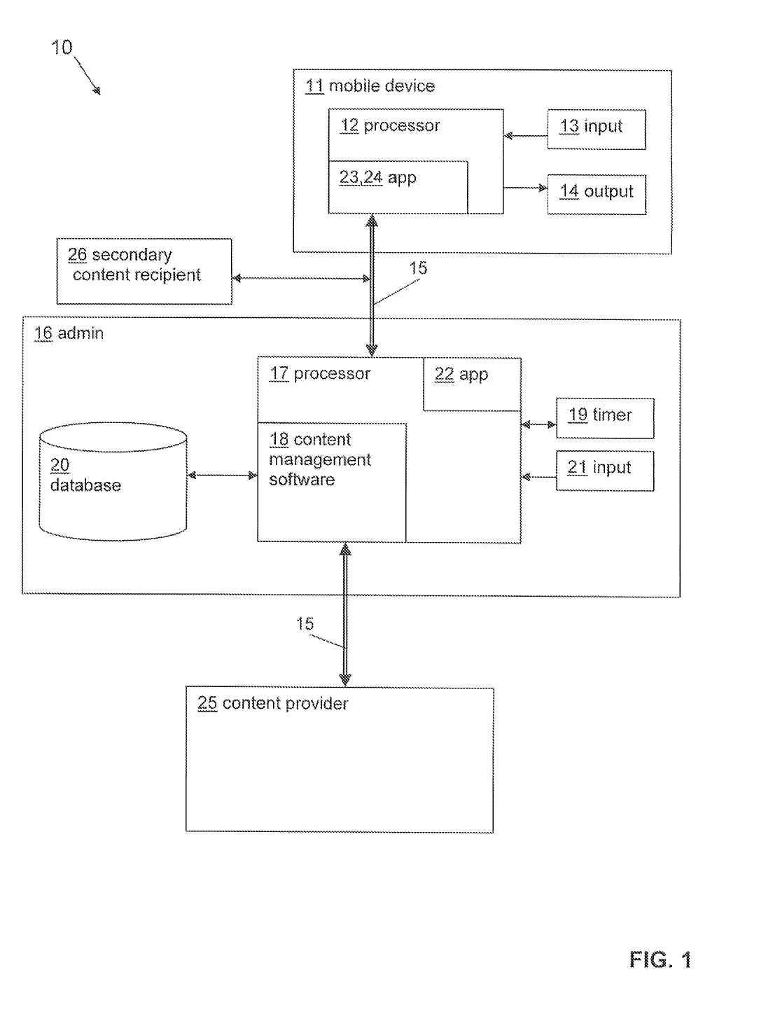

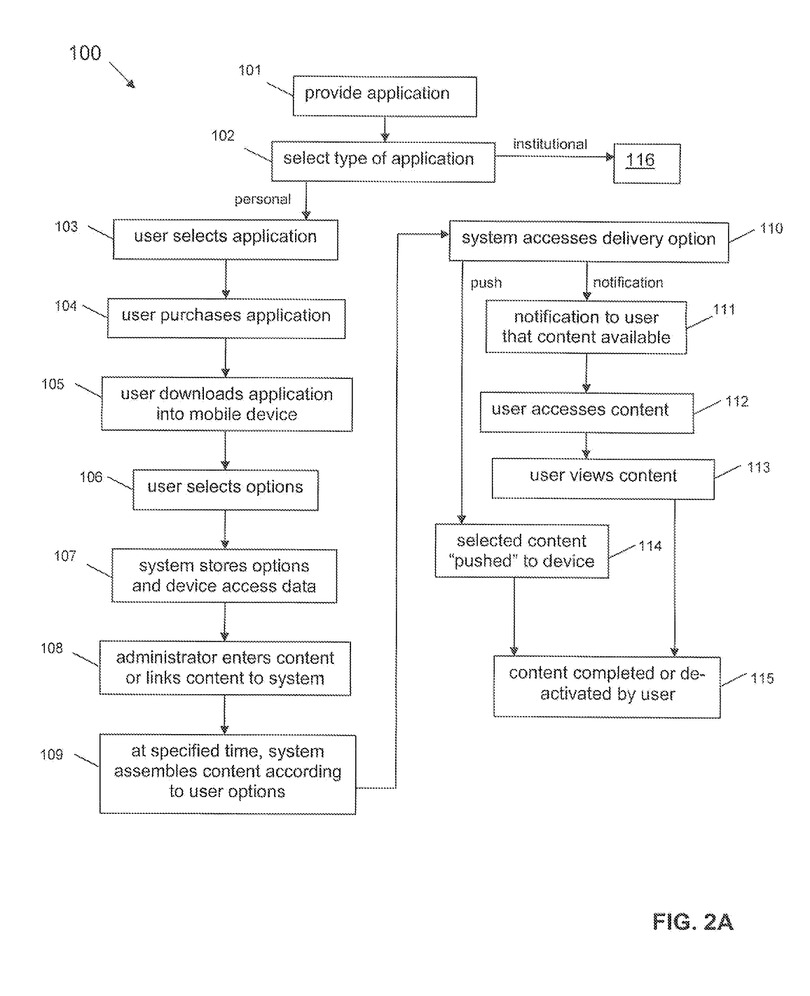

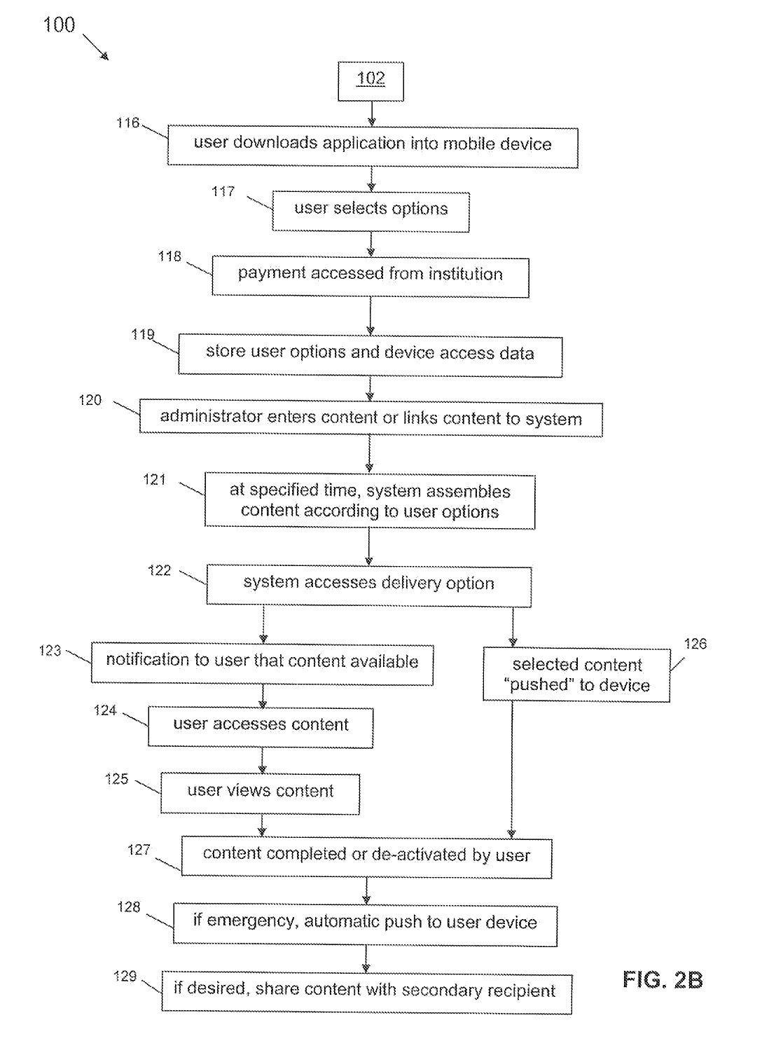

A detailed description of embodiments of a computer-readable storage medium and method will now be presented with reference to FIGS. 1-2B. One of skill in the art will recognize that these embodiments are not intended to be limitations on the scope of the invention, and that modifications are possible without departing from the spirit thereof.

The present invention is directed to systems and methods for delivering to and receiving content on a portable electronic device such as, but are not limited to, a laptop, smart telephone, cellular telephone, personal digital assistant, pager, text messaging device, voice recorder, handheld electronic device, and any electronic device that is capable or receiving, storing, or transmitting content over a network such as the Internet.

An aspect of the invention is directed to a system 10 (FIG. 1) and method 100 (FIGS. 2A,2B) for delivering informational content to and receiving informational content on a portable electronic device 11 at the user end. The device 11 has a processor 12 and an input 13, such as a keyboard and/or touch screen and/or microphone, and an output 14, such as a display screen and/or speaker, in signal communication with the processor 12. The processor 12 is connectable with a network such as the Internet 15 by means known in the art, and can include wireless communication.

The administration side 16 comprises a processor 17 placeable in signal communication with the Internet 15 and content management software 18 resident thereon. A timing device 19, a database 20, and an input 21 are in signal communication with the processor 17.

The administrator 16 provides an application 22 over the Internet 15 (block 101), for example, directly from the processor 17 or via a third-party vendor, as, for example, known in the art for iPhone® applications, although this is not intended as a limitation.

The system 10 and method 100 can comprise at least one of a “personal” application 23 or an “institutional” application 24 (block 102). In the personal application 23, a content provider 25, which may be the same entity as the administrator 16 or yet another entity, comprises means for delivering content electronically to the administrator processor 17, over the Internet 15 or internally over another network as desired and by means known in the art.

In the personal version, the user selects (block 103) and pays for (block 104) the application 23 by means known in the art, successful completion of which permits the user to download the application 23 into the device 11 (block 105). The user is permitted to select from a plurality of options (block 106), including, but not intended to be limited to, content delivery time, recurrence (e.g., every weekday, one-time event, etc.), type of content (e.g., news, sports, music, etc.), length of content to be delivered, and type of delivery (notification of availability or automatic “push”). The administrator processor 17 receives and stores these selected options and also data permitting access to the device 11 (block 107).

The administrator 16 enters content into the database 20, or provides a link thereto (block 108). This content may be pre-recorded prior to delivery or presented substantially in real time, and may comprise a plurality of types of content, including, but not limited to, content related to news, sports, business, health, entertainment, weather, and any other type of content. The content may be generated, for example, by substantially real-time on-air talent such as a newscaster. The content may include audio and/or video content for playing on the portable electronic device, information pages viewable on the informational video or accessible via a link in the informational video, graphics viewable on the informational video, etc. The content may have portions that are “commercial” in nature, that is, created by a third party for monetary gain, and/or “non-commercial” in nature, that is, created by a third party not for monetary gain. As one of skill in the art will appreciate the “third party” can comprise a for-profit or non-profit entity, such as, but not intended to be limited to, a corporation, a college, the military, or government entity.

The content can arise from one or more sources, such as, but not intended to be limited to, a newscast from a specific program, or newscasts from multiple programs, or varied content, such as that related to entertainment, stocks, sports, and news. The content management software 18 is adapted to manage the content uploads. The uploads may be made on any temporal basis desired, such as monthly, weekly, daily, hourly, real time, or on any other basis as determined the user and/or administrator, or may be predetermined by the content management system itself.

The content can also be sponsored by an entity, including for-profit and not-for-profit entities, individuals, etc. An electronic coupon may be included in the informational video wherein a user may view the coupon on a screen or display of the portable electronic device and use the coupon online, at a retail store, or any other location where such coupon is accepted. The electronic coupon may be downloadable from the informational video wherein a user may print the coupon and redeem the printed coupon at a retail store or any other location where such coupon must be physically presented. Additionally or in the alternative, the coupon may include a bar code viewable on the screen of the portable electronic device to permit a retailer or vendor to scan the bar code in order for the user to receive a discount. Moreover, a discount code may be located on the electronic coupon to permit a user, retailer, vendor, or any other entity to manually input the discount code into a system to permit the user to receive a discount. The term “electronic coupon” can also include gift cards, discount cards, reward cards, and any other type of document wherein a user may redeem the document with a retailer, vendor, or other third party to receive a value.

In accordance with the timer 19 and user-specified options, the content management software 18 assembles content for the user (block 109). If the user has elected to receive notification that content is available (block 110), such a notification is delivered to the device 11 (block 111) in the form, for example, of an audible tone or otherwise perceptible means. The user can then elect to access the content on the device 11 (block 112), for example, by selecting an icon, and then view the delivered content (block 113).

If the user has elected to receive the content directly (block 110), the administrator processor 17 delivers (“pushes”) the content to the user device 11 (block 114).

The user can continue to receive the content for the predetermined duration of the content or deactivate the content, as with any alarm system (block 115). The content can also be delivered in addition to, or instead of, a device alarm and can serve as a backup or supplemental alarm system as desired. Other features known in the art of alarm systems, such as “snooze,” can also be provided.

If the system 10 aspect is selected to comprise an “institutional” application 24 (block 102), again, the content provider 25 can comprise the same entity as the administrator 16 or yet another entity, such as the institution. The institution can comprise an educational institution or an employer, for example, although these are not intended as limitations.

As above, the user downloads the application 24 into the device 11 (block 116). The user is permitted to select from a plurality of options (block 117), including, but not intended to be limited to, institution identity, content delivery time, recurrence (e.g., every weekday, one-time event, etc.), and type of delivery (notification of availability or automatic “push”). In this case, the institution may provide payment to the administrator 15 (block 118). The administrator processor 17 receives and stores these selected options and also data permitting access to the device 11 (block 119).

The administrator 16 enters content into the database 20, or provides a link thereto (block 120). This content may be pre-recorded prior to delivery or presented substantially in real time, and may comprise a plurality of types of content, including, but not limited to, content related to the institution, such as institution events, closing times, or the other types of content listed previously, or a combination thereof. The content may include audio and/or video content for playing on the portable electronic device, information pages viewable on the informational video or accessible via a link in the informational video, graphics viewable on the informational video, etc.

In accordance with the timer 19 and user-specified options, the content management software 18 assembles content for the user (block 121). If the user has elected to receive notification that content is available (block 122), such a notification is delivered to the device 11 (block 123) in the form, for example, of an audible tone or otherwise perceptible means. The user can then elect to access the content on the device 11 (block 124), for example, by selecting an icon, and then view the delivered content (block 125).

If the user has elected to receive the content directly (block 122), the administrator processor 17 delivers (“pushes”) the content to the user device 11 (block 126).

As above, the user can continue to receive the content for the predetermined duration of the content or deactivate the content, as with any alarm system (block 127). The content can also be delivered in addition to, or instead of, a device alarm and can serve as a backup or supplemental alarm system as desired. Other features known in the art of alarm systems, such as “snooze,” can also be provided.

An additional feature of the institutional application 24, which could also be incorporated into the personal application 23 as desired, comprises the ability to “push” informational content in other situations, such as in an emergency (block 128). Examples of this usage could include a school being closed in bad weather, a function being canceled, or a facility being shut down unexpectedly.

Further, content provided to either the institutional 24 or personal 23 application can be shared with a secondary recipient 26 (block 129) via means known in the art such as, but not intended to be limited to, a social network, email, or a site such as YouTube.

Having now described the invention, the construction, the operation and use of preferred embodiments thereof, and the advantageous new and useful results obtained thereby, the new and useful constructions, and reasonable mechanical equivalents thereof obvious to those skilled in the art, are set forth in the appended claims.

What is claimed is:

1. A system for delivering informational content to a portable electronic device comprising:
a processor placeable in signal communication with a network;
a timer in signal communication with the processor;
a database accessible by the processor;
software resident on the processor comprising code segments adapted for:
providing an application available to and loadable on a mobile device of a user;
receiving over the network access data for the user device and a user selection of a time to receive content;
storing in the database the user device access data and time selection;
receiving and storing in the database deliverable content;
substantially at the user-selected time, assembling content; and
making available to the user device via the network the assembled content.

2. The system recited in claim 1, wherein the software further comprises code segments adapted for, via the network, notifying the user device substantially at the user selected time that the assembled content is available for user access, receiving a signal from the user device to deliver the assembled content, and pushing the assembled content to the user device.

3. The system recited in claim 1, wherein the software further comprises a code segment adapted for automatically pushing, via the network, the assembled content to the user device substantially at the user selected time.

4. The system recited in claim 1, wherein the software further comprises a code segment adapted for receiving, via the network, a user selection of a desired time duration of the assembled content, and wherein the content-assembling code segment comprises a code segment adapted for assembling content having a duration substantially equal to the user-selected time duration.

5. The system recited in claim 1, wherein the software further comprises a code segment adapted for, via the network, receiving a user selection of a type of content, and wherein the content-assembling code segment comprises a code segment adapted for assembling content of a type commensurate with the user-selected type.

6. The system recited in claim 1, wherein the software further comprises a code segment adapted for, via the network, receiving a user affiliation to an institution, and wherein at least some of the deliverable content is related to the institution.

7. The system recited in claim 1, wherein the software further comprises code segments adapted for receiving and storing in the database content relating to a emergency situation and for, via the network, automatically pushing at least some of the emergency-situation-related content to the user device.

8. The system recited in claim 1, wherein the content comprises a substantially real-time news feed.

9. A system for providing informational content to a user comprising:
a portable electronic device comprising a processor placeable in signal communication with a network, and an input and an output in signal communication with the processor;
an application resident on the device processor comprising code segments adapted for:
receiving via the input a user selection of a time to receive content;
transmitting the user-selected time to an administrator site over the network; and
accessing content assembled and delivered by the administrator site at substantially the user-selected time.

10. The system recited in claim 9, wherein the content-accessing code segment comprises a code segment adapted for receiving via the input a signal to display the assembled content on the display, transmitting a signal from the processor over the network to the administrator site to deliver at least some of the assembled content, receiving at least some of the assembled content from the administrator site over the network into the processor, and displaying at least some of the received assembled content on the display.

11. The system recited in claim 9, wherein the software further comprises a code segment adapted for automatically receiving the assembled content substantially at the user selected time via a pushing from the administrator site over the network.

12. The system recited in claim 9, wherein the software further comprises code segments adapted for receiving a user selection via the input of a desired time duration of the assembled content and for transmitting the user-selected desired time duration to the administrator site over the network.

13. The system recited in claim 9, wherein the software further comprises code segments adapted for receiving via the input a user selection of a type of content and for transmitting the user-selected content type to the administrator site over the network.

14. The system recited in claim 9, wherein the software further comprises code segments adapted for receiving via the input a user affiliation to an institution and for transmitting the user affiliation to the administrator site over the network, and wherein at least some of the delivered content is related to the institution.

15. The system recited in claim 9, wherein the software further comprises a code segment adapted for receiving from the administrator site over the network content relating to a emergency situation and for automatically displaying at least some of the emergency-situation-related content on the display.

16. A method for delivering informational content to a portable electronic device over a network comprising:
providing an application available to and loadable on a mobile device of a user, the mobile device connectable with a network;
receiving over the network access data for the user device and a user selection of a time to receive content;
storing the user device access data and time selection;
receiving and storing deliverable content;
substantially at the user-selected time, assembling content; and
making available to the user device via the network the assembled content.

17. The method recited in claim 16, wherein further comprising, via the network, notifying the user device substantially at the user selected time that the assembled content is available for user access, receiving a signal from the user device to deliver the assembled content, and pushing the assembled content to the user device.

18. The method recited in claim 16, further comprising automatically pushing, via the network, the assembled content to the user device substantially at the user selected time.

19. The method recited in claim 16, further comprising receiving, via the network, a user selection of a desired time duration of the assembled content, and wherein the content-assembling step comprises assembling content having a duration substantially equal to the user-selected time duration.

20. The method recited in claim 16, further comprising receiving a user selection, via the network, a type of content, and wherein the content-assembling step comprises assembling content of a type commensurate with the user-selected type.

21. The method recited in claim 16, further comprising receiving a user affiliation to an institution over the network, and wherein at least some of the deliverable content is related to the institution.

22. The method recited in claim 16, further comprising receiving and storing content relating to a emergency situation and automatically pushing at least some of the emergency-situation-related content to the user device over the network.

23. The method recited in claim 16, wherein the content comprises a substantially real-time news feed.

24. A method for receiving informational content over a network into a mobile device comprising:
inputting into the mobile device a user selection of a time to receive content;
transmitting over the network the user-selected time to an administrator site over the network; and
accessing content assembled and delivered by the administrator site at substantially the user-selected time.

25. The method recited in claim 24, wherein the content-accessing step comprises receiving a signal to display the assembled content on the display, transmitting a signal from the processor over the network to the administrator site to deliver at least some of the assembled content, receiving at least some of the assembled content from the administrator site over the network into the processor, and displaying at least some of the received assembled content on the display.

26. The method recited in claim 24, further comprising automatically receiving the assembled content substantially at the user selected time via a pushing from the administrator site over the network.

27. The method recited in claim 24, further comprising receiving a user selection of a desired time duration of the assembled content and transmitting the user-selected desired time duration to the administrator site over the network.

28. The method recited in claim 24, further comprising receiving a user selection of a type of content and transmitting the user-selected content type to the administrator site over the network.

29. The method recited in claim 24, further comprising receiving a user affiliation to an institution and transmitting the user affiliation to the administrator site over the network, and wherein at least some of the delivered content is related to the institution.

30. The method recited in claim 24, further comprising receiving from the administrator site over the network content relating to a emergency situation and automatically displaying at least some of the emergency-situation-related content on the device.
